(19) United States
(12) Patent Application Publication
(10) Pub. No.: US 2009/0189557 A1
(43) Pub. Date: Jul. 30, 2009

(54) METHOD AND ARRANGEMENT FOR CONTROLLING AN ELECTRIC DRIVE

(75) Inventors: Karl-Hermann KETTELER, Markdorf (DE); Jurgen KETT, Friedrichshafen (DE); Mesut ER, Friedrichshafen (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/347,109

(22) Filed: Dec. 31, 2008

(30) Foreign Application Priority Data
Jan. 25, 2008 (DE) 10 2008 000 146.5

(51) Int. Cl. H02H 7/08

(52) U.S. Cl. 318/400.21

(57) ABSTRACT

A method for controlling an electric drive is proposed, in which, in the event of a fault, a motor control unit of an electric motor implements a safety measure to change over to a secure operating condition, such that when a faulty three-phase current feed to the electric motor is detected, a fault-associated operating mode is activated. In addition, an arrangement for controlling an electric drive comprising an electric motor with a motor control unit is proposed, which implements a safety measure in the event of a fault so as to change over to a secure operating condition, such that when a faulty three-phase current feed to the electric motor is detected, the motor control unit activates a fault-associated operating mode.

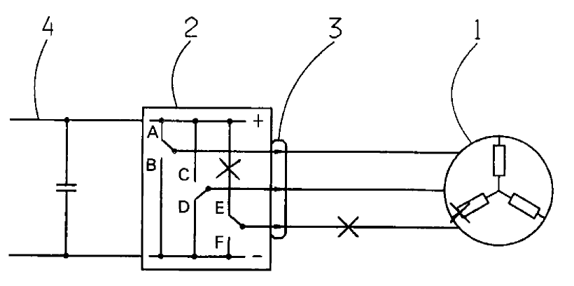

This application claims priority from German Application Serial No. 10 2008 000 146.5 filed Jan. 25, 2008.

### FIELD OF THE INVENTION

The present invention concerns a method and an arrangement for controlling an electric drive.

### BACKGROUND OF THE INVENTION

From automotive technology hydraulic drives for vehicle components are known. In order to maintain these known arrangements in an operational condition of the drive, even in the event of a fault, the pressure oil supply can be interrupted by closing off an oil duct. In addition, electric motor drives are known for vehicle components. Compared with hydraulic drives, they have the advantage that no pressure medium is needed, so the energy for powering a pressure oil pump can also be saved. Advantageously, the unused power can be used instead for powering the vehicle.

In the case of an electric motor drive, to be able to maintain an operational condition if a fault occurs, a predetermined braking torque must be applied to the drive even in the event of sudden failure of the current supply. For that purpose, the drive is electrically short-circuited, via a low-impedance cable. This short-circuit is switched by a relay. However, it has been shown that in view of the high dynamics of the electric motor drive, the reaction time of the relay, is not sufficiently rapid to provide a guarantee that the drive can be changed to a secure or fail-safe condition.

The purpose of the present invention is to propose an arrangement and a method of the type described above, such that safety-critical conditions of the drive are avoided.

### SUMMARY OF THE INVENTION

Accordingly, a method for controlling an electric drive is proposed in which a motor control unit of an electric motor implements a safety measure in the event of a fault so as to change over to a secure operating condition of the motor, such that if faulty three-phase, current feeding of the electric motor is detected, a fault-associated operating mode or suchlike is initiated or activated.

In this way, despite an asymmetry fault in the supply line of the electric motor or in a power output stage of the motor control unit, by way of the fault-associated operating mode, a sufficient braking torque can be produced at the electric motor so that the motor is maintained in operational condition and a safety-critical situation is avoided.

In the said fault-associated operating mode, if one phase of a three-phase feed is out of action, a direct current can be fed to the electric motor, via the remaining phases. In this way, the partial redundancy in the electric actuator is utilized to produce a single-phase supply so as to maintain the electric motor in the condition in which it was shortly before or when the fault was detected.

By feeding a predetermined direct current to the electric motor, via the remaining phases, the motor is virtually completely braked so that the electric drive is bought to a fail-safe condition.

The objective of the invention is also achieved by an arrangement for controlling an electric drive comprising an electric motor with a motor control unit, which implements a safety measure in the event of a fault in order to change over to a secure operational condition, such that if faulty three-phase feeding of the electric motor is detected. The motor control unit activates a fault-associated operational mode.

In the fault-associated operational mode of the motor control unit a predetermined direct current can be switched from the main power system to the remaining phases, thus producing a single-phase supply to the electric motor that results in a braking torque sufficient to maintain the electric motor in the condition in which it was before the fault was detected.

Preferably, the proposed method can be implemented with the arrangement according to the invention. Other applications are also conceivable.

### BRIEF DESCRIPTION OF THE DRAWINGS

The invention will now be described, by way of example, with reference to the accompanying drawings in which:

The single FIGURE shows a schematic view of a circuit for an arrangement, according to the invention, for controlling an electric drive, for example for a vehicle component, the latter not being illustrated further.

### DETAILED DESCRIPTION OF THE INVENTION

The drive comprises a synchronous motor 1 which can be controlled by a motor control unit. The motor control unit comprises at least a power output stage or a power electronic stage 2. The power electronic stage 2 is supplied with energy from a main power system 4 or an intermediate network. The power electronic stage 2 comprises a bridge circuit (B6), indicated by the reference letters A to F, and a three-phase current feed 3 for the synchronous motor 1. The synchronous motor 1 is supplied via the three-phase rotary current feed 3.

When a failure of one phase of the three-phase, current feed 3 is detected, (indicated in the drawing by crosses), according to the invention, a fault-associated operating mode is activated by the motor control unit. Thereby, a sufficiently large direct current is applied to the synchronous motor 1 by the power electronic stage 2, via the remaining two phases of the three-phase feed 3. Thus, the synchronous motor 1 can be maintained stable in the condition in which it was before the occurrence of the fault. Functionally, the synchronous motor 1 behaves as if it had been firmly braked. As a result, the arrangement produces a stable, fail-safe condition.

### REFERENCE NUMERALS

1 synchronous motor
2 power electronic stage of the motor control unit
3 three-phase current feed
4 main power system
A switch
B6 bridge circuit
B switch
C switch
D switch
E switch
F switch

1-5. (canceled)

6. A method of controlling an electric drive, in which, in an event of a fault, a motor control unit of an electric motor implements a safety measure to change over to a secure operating condition, the method comprising the steps of activating a fault-associated operation when a faulty three-phase current feed to the electric motor is detected.

7. The method according to claim 6, further comprising the step of supplying a direct current to the electric motor via remaining phases if one phase of the three-phase current feed fails.

8. The method according to claim 7, further comprising the step of firmly braking the electric motor when the electric motor is supplied with the direct current.

9. An arrangement for controlling an electric drive, the arrangement comprising an electric motor with a motor control unit, which implements a safety measure in an event of a fault so as to change over to a secure operating condition, when a faulty three-phase current feed to the electric motor is detected, the motor control unit activates a fault-associated operating mode.

10. The arrangement according to claim 9, wherein a power electronic stage (2) of the motor control unit directs a predetermined direct current from a main power system (4) to operational phases.

11. A method of controlling an electric drive during a failure in the electric drive, the method comprising the steps of:
detecting a failure in a phase of a three-phase electrical current feed to the electric motor;
supplying a direct current to the electrical motor through two functional phases of the three-phase electrical current feed; and
firmly braking the electric motor with the direct current supplied to the electric motor.
